(19) United States
(12) Patent Application Publication
(10) Pub. No.: US 2010/0017314 A1
(43) Pub. Date: Jan. 21, 2010

(54) TRAVEL EXPENSE MANAGEMENT SYSTEM

(75) Inventors: Bruce E. Johnson, Bellevue, WA (US); Marc Mercuri, Bothell, WA (US); Alison Clark, Earley (GB); Martin Grayson, Bedford (GB); Rimes Mortimer, Mercer Island, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/274,353

(22) Filed: Nov. 20, 2008

Related U.S. Application Data
(60) Provisional application No. 61/081,367, filed on Jul. 16, 2008.

(51) Int. Cl. G06Q 10/00

(52) U.S. Cl. 705/30

(57) ABSTRACT

A method for generating an expense report, comprising: receiving an itinerary for travel, generating a description and a cost for one or more travel elements of the itinerary; and generating projected expenses that are expected to be incurred based on historical data associated with the itinerary

### CROSS-REFERENCE TO RELATED APPLICATIONS

This application claims benefit of U.S. provisional patent application Ser. No. 61/081,367, filed Jul. 16, 2008, which is herein incorporated by reference.

This application is related to U.S. patent application Ser. No. ______, titled, TRAVEL MANAGEMENT SYSTEM, filed on the same day as the present application.

### BACKGROUND

Many travel service providers, such as airlines, hotels, and car rental companies exploit the wide availability of access to the Internet to sell services directly to passengers, without intermediaries, such as travel agents. As a result, many travel agencies have developed an Internet presence by creating websites with detailed travel information. In addition to the traditional travel agencies, full service travel sites have arisen that also use the Internet for selling travel services. Travel sites typically use travel service distribution companies who operate Global Distribution Systems (GDS), to provide up to the minute, detailed information on flight, hotel, and car rental vacancies.

### SUMMARY

Described herein are implementations of various technologies for a travel management system. In one implementation, a state-based desktop client provides a travel planning and management workspace for the user. The user may perform travel planning activities, and log out of the travel workspace without having to repeat travel planning tasks. In another implementation, travel planning tasks may be stored as data feeds that keep up-to-date fare and availability data even when the user is not logged into the travel workspace.

In another implementation, information about travel services such as transportation, lodging, and entertainment may be stored in a customizable, highly-indexable, travel card format. The travel card format may help providers of travel services provide information about travel services within an interactive presentation layer. The user may perform free-form searches against the travel cards when searching for travel services instead of the rigid, structured search format that is typical of travel sites.

In another implementation, a virtual travel agent may help plan and secure travel arrangements in concert with enterprise data services that inform the virtual travel agent of the user's availability, user preferences, and corporate policies for planning and booking travel. The virtual travel agent may monitor departures, arrivals, and trip disruptions in order to provide timely notifications to the user and others reliant upon news of trip events and disruptions. The virtual travel agent may monitor the user's progress during a trip, and re-book travel in the event of travel disruptions.

In another implementation, an expense report may be generated based on a suggested itinerary. The expense report may include projected expenses that are based on historical itineraries. The expense report may be used in an approval process before the virtual travel agent secures travel arrangements.

In another implementation, expense items incurred during travel may be submitted and reconciled electronically, using corporate expense policies stored in the enterprise data services.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A illustrates a schematic diagram of a computing system in which the various technologies described herein may be incorporated and practiced.

FIG. 1B illustrates a travel management server and travel service provider server in more detail, in accordance with implementations described herein.

FIG. 1C illustrates a travel card system, in accordance with implementations described herein.

FIG. 2A illustrates a screen shot of a travel workspace client, in accordance with implementations of various technologies described herein.

FIG. 2B illustrates a travel binder, in accordance with implementations described herein.

FIG. 2C illustrates a travel card interface, in accordance with implementations described herein.

FIG. 3 illustrates a flow chart of a method for creating an itinerary, according to implementations of various technologies described herein.

FIG. 4 illustrates a flow chart of a method for generating expense reports, in accordance with implementations described herein.

FIG. 5 illustrates a flow chart of a method for validating travel expenses, according to implementations of various technologies described herein.

### DETAILED DESCRIPTION

As to terminology, any of the functions described with reference to the figures can be implemented using software, firmware, hardware (e.g., fixed logic circuitry), manual processing, or a combination of these implementations. The term “logic, “module,” “component,” or “functionality” as used herein generally represents software, firmware hardware, or a combination of these implementations. For instance, in the case of a software implementation, the term “logic,” “module,” “component,” or “functionality” represents program code (or declarative content) that is configured to perform specified tasks when executed on a processing device or devices (e.g., CPU or CPUs). The program code can be stored in one or more computer readable media.

More generally, the illustrated separation of logic, modules, components and functionality into distinct units may reflect an actual physical grouping and allocation of such software, firmware, and/or hardware, or may correspond to a conceptual allocation of different tasks performed by a single software program, firmware program, and/or hardware unit. The illustrated logic, modules, components, and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, solid state, etc.). The term machine-readable media also encompasses transitory forms of representing information, including various hardwired and/or wireless links for transmitting the information from one point to another.

The techniques described herein are also described in various flowcharts. To facilitate discussion, certain operations are described in these flowcharts as constituting distinct steps performed in a certain order. Such implementations are exemplary and non-limiting. Certain operations can be grouped together and performed in a single operation, and certain operations can be performed in an order that differs from the order employed in the examples set forth in this disclosure.

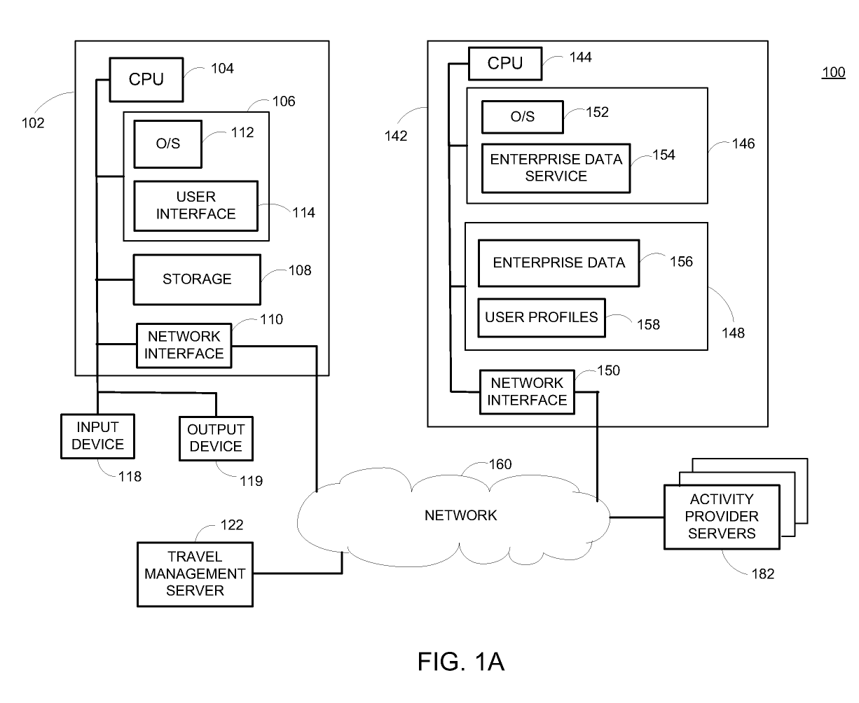

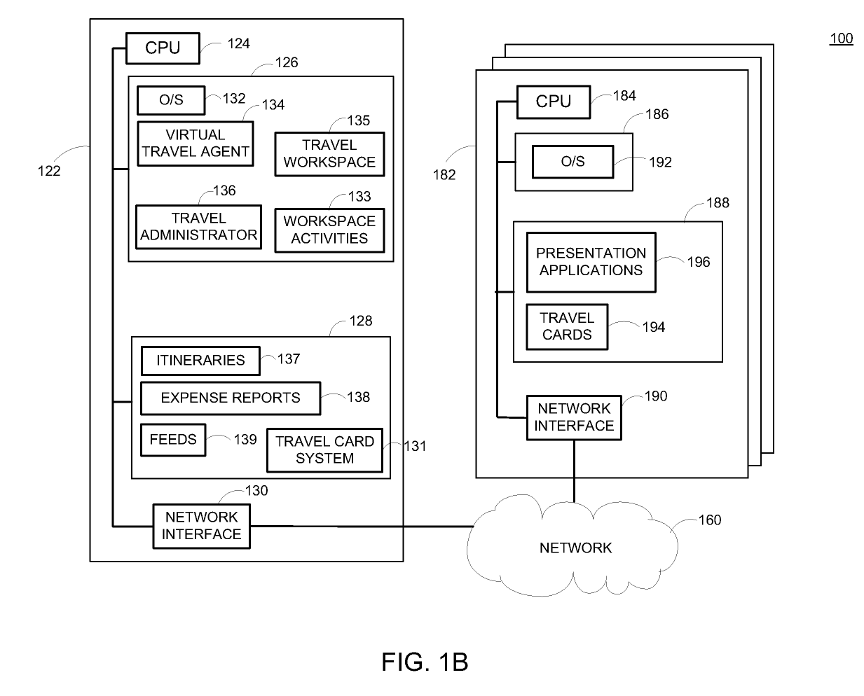

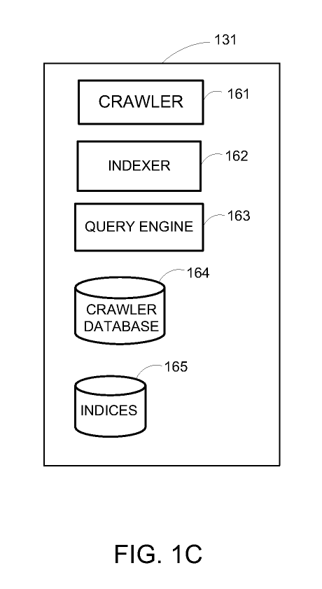

FIG. 1A illustrates a schematic diagram of a computing system 100 in which the various technologies described herein may be incorporated and practiced. Although the computing system 100 may include conventional desktop or server computers, other computer system configurations may be used.

The computing system 100 may be built around a standard set of web service protocols and XML schemas which enable interoperability between enterprise systems and a Global Distribution Systems (GDS) service infrastructure. By using web services for communication, the architecture ensures an open model in which multiple companies can participate in the development of new services and solutions.

The computing system 100 may include one or more client computers 102, a travel management server 122, an enterprise server 142, and various travel service provider servers 182. The client computer 102 may provide a user with an interface through which the user may request travel services and view travel service information. Travel service information may include information about travel itineraries and varying forms of transport, lodging, and entertainment. For example, the user may request an itinerary for a business trip from Seattle to London, which may include requests for available flights, hotel rooms, and restaurant reservations.

The travel management server 122 may host traveler-centric software to help users plan and manage travel. Travel management may include creating itineraries, booking travel reservations, and expense report management. In one implementation, the travel management server 122 may interface with GDS (not shown) to search and book available transport and lodging. By interfacing with GDS, the user may have access to the same data and choices that a human travel agent could provide. The travel management server 122 is described in greater detail with reference to FIG. 1B.

The travel service provider servers 182 may provide travel-related content to users searching for, and securing, travel services. A travel service provider may be any organization that provides some travel service. Travel services may include transport, accommodations, and attractions such as parks, museums, concert halls, or any venue related to travel or tourism. The travel service provider servers 182 may provide the user with dynamic access to information about travel services. Additionally, the travel service provider servers 182 may provide a rich, interactive presentation to inform users about travel services, and help the user make travel choices. The travel service provider servers 182 are described in greater detail with reference to FIG. 1B.

The enterprise server 142 may host enterprise software that interfaces with the travel management server 122. Further, the enterprise server 142 may host enterprise data 156, such as corporate policies and preferences that may be used for travel planning and management. The enterprise data 156 may be represented at different levels of abstraction within the enterprise.

The client computer 102 may include a central processing unit (CPU) 104, a system memory 106, a storage 108, and a network interface 110. Although only one CPU 104 is illustrated in the client computer 102, it should be understood that in some implementations the client computer 102 may include more than one CPU 104.

The system memory 106 may include a read only memory (ROM), a random access memory (RAM), and a basic input/output system (BIOS) (none of which are shown). The BIOS may contain the basic routines that help transfer information between elements within the client computer 102, such as during start-up.

The storage 108 may include a hard disk drive for reading from and writing to a hard disk, a magnetic disk drive for reading from and writing to a removable magnetic disk, and an optical disk drive for reading from and writing to a removable optical disk, such as a CD ROM or other optical media. The drives and their associated computer-readable media may provide nonvolatile storage of computer-readable instructions, data structures, program modules and other data for the client computer 102. The drives are not shown in FIG. 1A.

Although the client computer 102 is described herein as having a hard disk, a removable magnetic disk, and/or a removable optical disk, it should be appreciated by those skilled in the art that the client computer 102 may also include other types of computer-readable media that may be accessed by a computer. For example, such computer-readable media may include computer storage media and communication media.

Computer storage media may include volatile and non-volatile, and removable and non-removable media implemented in any method or technology for storage of information, such as computer-readable instructions, data structures, program modules or other data.

Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the client computer 102.

Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal.

By way of example, and not limitation, communication media may include wired media such as a wired network or direct-wired connection, and wireless media such as acoustic, RF, infrared and other wireless media. Combinations of any of the above may also be included within the scope of computer readable media.

Further, the client computer 102 may operate in a networked environment using logical connections to one or more remote computers, such as the travel management server 122, the enterprise server 142, and the travel service provider servers 182. The logical connections may include the network interface 110, connected to a network 160. The network 160 may be any network or collection of networks, such as enterprise-wide computer networks, intranets, local area networks (LAN), and wide area networks (WAN). In one implementation, the network 160 may be the Internet.

Additionally, the user may enter commands and information into the client computer 102 through input devices 118. The input devices 118 may include devices such as a keyboard and pointing device. Other input devices 118 may include a microphone, joystick, game pad, satellite dish, scanner, or the like.

The client computer 102 may also include one or more output devices 119. The output devices 119 may include a display monitor, or other peripheral output devices, such as speakers and printers.

The system memory 106 may contain an operating system 112 and a user interface 114. The operating system 112 may be any suitable operating system that may control the operation of a networked desktop, laptop, or mobile computing device. The operating system 112 may include Windows® Vista, Windows® Mobile, Mac OS® X, Unix-variants (e.g., Linux® and BSD®), and the like.

The user interface 114 may be software that receives travel-related requests from a user, performs traditional web service related tasks, and presents travel-related data to the user. Traditional web service related tasks may include authentication and data management tasks. Travel-related requests may include searches for travel services, and requests for travel services, such as making reservations or booking travel transport requests. Travel requests may also include queries about active travel itineraries. For example, the user may request a departure time for a connecting flight during a trip. The user interface 114 may receive requests via keyboard entry, or voice queries.

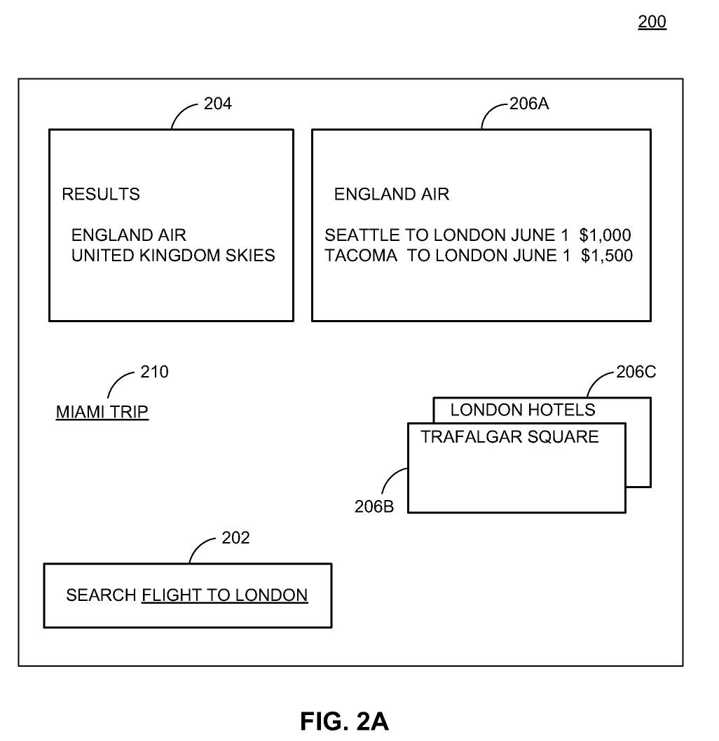

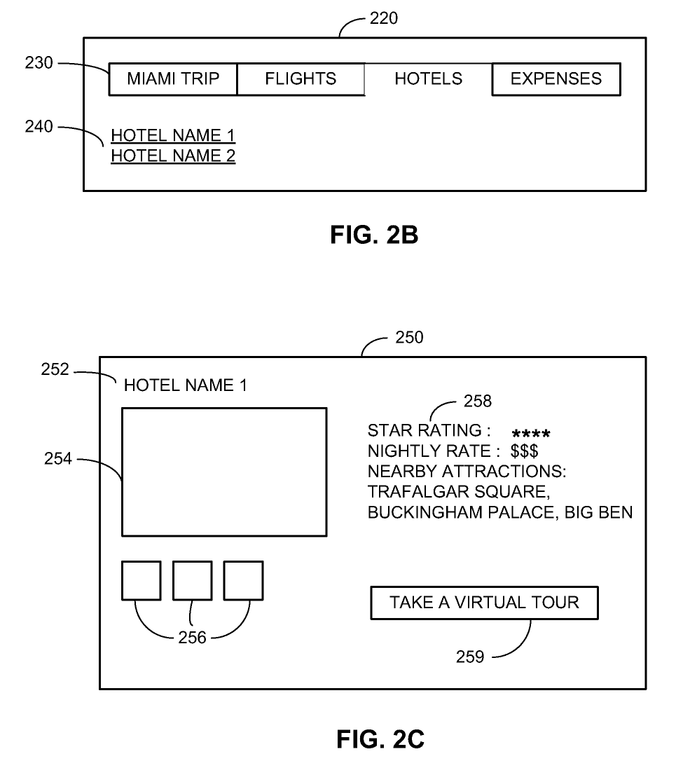

The user interface 114 may present travel-related data in a display or via a voice message. The user interface 114 may be a web client, a mobile client, or a voice client. One example of a web client is described in greater detail with reference to FIG. 2A. In one implementation, the user interface 114 may be a web client built on top of Microsoft® Silverlight and ASP.NET.

Because mobile devices go in and out of coverage, are operated on airlines and other “radio off” locales, the user interface 114 for the mobile client may support a rich offline model for data access. The mobile client may cache and render a series of travel data which enable the mobile projection of data. In one implementation, the mobile client may use a data feed caching mechanism to track and store data for online and offline operation. Additionally, because of the limited resources typical of mobile devices, the data that is displayed in the mobile client may be limited. In one implementation, the user interface 114 may be a mobile client built on top of Windows® Mobile and the .NET Compact Framework.

In an implementation where the user interface 114 includes a voice client, the user may access the voice client via a direct dial number (e.g., 1-800-XXX-XXXX) which any user may dial to access travel service data. Caller ID functionality may be used to automatically identity users from their preferred telephony devices and telephone numbers.

For example, upon receiving a call from the user to the direct dial number, the voice client may prompt the user for a voice query that indicates the type of assistance required. Advantageously, the user does not have to follow a series of menu prompts to get directly to the information the user needs. Rather, the user may make a simple query, such as, “When is my next flight?”, or “Which hotel am I booked into for tonight?” In response, the virtual travel agent 134 may determine the active itinerary 137 for the user, and provide the answer to the user's question. In one implementation, the user interface 114 may be a voice client built on top of the Microsoft® Tellme platform.

The voice client may use a travel grammar that includes common queries such as described above. In one implementation, the travel grammar may be developed using the VoiceXML standard. In another implementation, the voice client may handoff incoming calls to various travel services providers at the user's request. Advantageously, the user need only remember the one direct dial telephone number instead of the numerous telephone numbers for all of the airlines, hotels, and car rental companies that may be used on a given trip.

In yet another implementation, the user interface 114 may be integrated with an enterprise data service 154 such as a calendar. In one implementation, the enterprise data service 154 may be a locator service, such as Microsoft® Office Communication Server that determines a current location of the user.

The enterprise server 142 may be similarly configured to the client computer 102. The enterprise server 142 may include a CPU 144, system memory 146, storage 148, and a network interface 150.

The system memory 146 may include an operating system 152 and the enterprise data service 154. The enterprise data service 154 may be any software that manages business, or office-related tasks, such as calendars and communication services (e.g., e-mail). The enterprise data service 154 may maintain enterprise data 156 that is relevant to travel planning and management, such as the user's availability for travel, and the user's location.

The storage 148 may include the enterprise data 156 and user profiles 158. The enterprise data 156 may also include enterprise-level data for managing business travel. For example, the enterprise-level data may include corporate policies for authorizing travel, preferred vendors for travel services, required authorizations for purchasing travel, corporate credit card numbers for purchasing services, and the like.

The user profiles 158 may include user-level data for making travel service decisions. User-level data may include preferences for travel, such as seating on airlines, smoking v. non-smoking accommodations, special dietary needs, a user's credit card numbers for purchasing travel services, and the like.

FIG. 1B illustrates the travel management server 122 and the travel service provider server 182 in more detail, in accordance with implementations described herein. The travel service provider server 182 may be similarly configured to the client computer 102. The travel service provider servers 182 may include a CPU 184, system memory 186, storage 188, and a network interface 190. The system memory 186 may include an operating system 192.

The storage 188 may include travel cards 194 and presentation applications 196. The travel cards 194 may be documents that describe travel services or activities. The travel cards 194 may provide additional details about travel services, such as points of interest, maps, contact information, photographs, etc. The travel cards may describe travel services and activities at numerous levels of abstraction. For example, one travel card 194 may describe a hotel room, while another travel card describes the entire hotel. In one implementation, the travel cards 194 are extensible markup language (XML) documents.

The travel cards 194 may also be associated with the presentation applications 196. Additionally, the travel cards 194 may provide an advertising channel for travel service providers to create and deliver paid content to the user. The travel cards 194 may be fully indexable for any tag defined by the travel service providers. Advantageously, being fully indexable enables the user to conduct searches with a flexible search format instead of the rigid search structures of the typical travel service website.

In addition to text descriptions that may be included in the travel cards 194, the presentation applications 196 may provide interactive content to the user viewing a particular service or activity within the user interface 114. In one implementation, the presentation applications 196 may be Microsoft® Silverlight applications.

Additionally, the travel cards 194 may provide a simple way to share information relevant to the user's trip. For example, one user may send the travel card 194 for a restaurant to other people so that everyone can find the restaurant. In one implementation, the travel cards 194 may include a local language option to enable the user to show the travel card 194 to taxis, or hotel staff for directions. FIG. 2C illustrates an example of the travel card 194 for a hotel and will be described in more detail in the paragraphs below. The travel cards 194 may also be organized within travel binders. FIG. 2B illustrates an example travel binder and will be described in more detail in the paragraphs below.

The travel management server 122 may be similarly configured to the client computer 102. The travel management server 122 may include a CPU 124, system memory 126, storage 128, and a network interface 130.

The system memory 126 may include an operating system 132, workspace activities 133, a virtual travel agent 134, a travel workspace application 135, and a travel administrator 136. The virtual travel agent 134 may be software that performs services similar to a real-life travel agent. For example, the virtual travel agent 134 may receive requests from the user for travel services. The virtual travel agent 134 may select, purchase, reserve, or hold travel services based on the request. Additionally, the virtual travel agent 134 may plan and manage travel services based on the enterprise data 156 and the user profile 158.

Additionally, the virtual travel agent 134 may manage active itineraries for the user. For example, the virtual travel agent 134 may subscribe to data feeds for travel elements of the user's itinerary 137. Through the data feeds 139, the virtual travel agent 134 may monitor travel events, such as flight delays or cancellations, weather disruptions, departures, and arrivals. Further, in response to travel events, the virtual travel agent 134 may send notifications via the user interface 114, text messaging, voice messaging, or a data feed. Notifications may be sent to the user, or other recipients designated by the user, e.g., family, colleague, or the hotel where the user is staying.

In one implementation, the virtual travel agent 134 may vary the type of notification based on the content. For example, a flight delay of 10 minutes may trigger a text message to the user. However, a flight delay of an hour may trigger a voice message to the user. The type of notification may also vary based on the recipient.

With regard to voice messaging, the virtual travel agent 134 may initiate a phone call to the user that allows for limited interaction with a voice client. For example, when calling the user about an overnight flight delay, the voice client may respond to the user's query about local hotels.

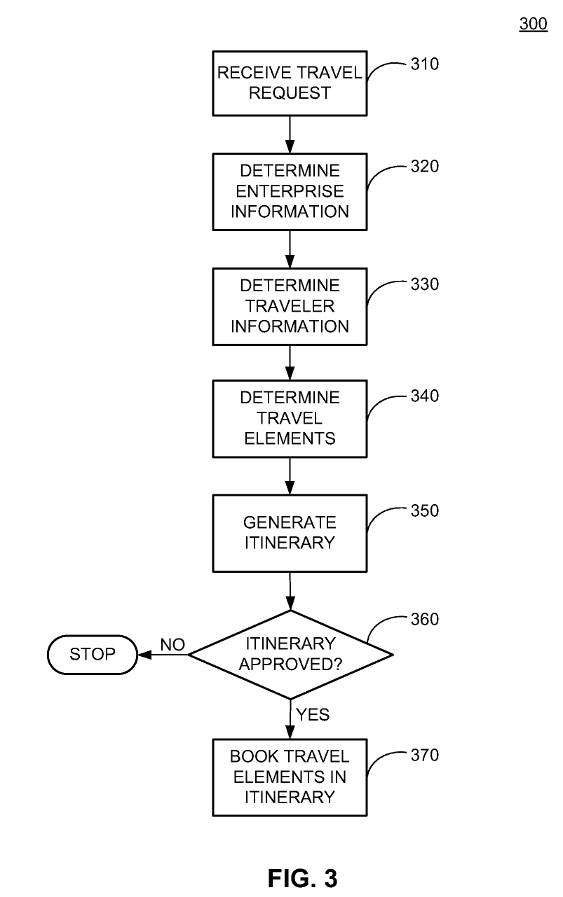

The virtual travel agent 134 may also associate multiple itineraries 137 as part of a group, e.g., a business trip with multiple colleagues, a family vacation. The virtual travel agent 134 is described in greater detail with reference to FIG. 3.

The travel workspace application 135 may be software that processes user requests to provide information about travel services to the user interface 114. The travel workspace application 135 may maintain state data about specific user requests and itineraries 137 in the workspace activities 133.

In one implementation, the travel workspace application 135 may create the data feeds 139 to maintain updated information about travel services. The data feeds 139 may be really simple syndication (RSS) or ATOM data feeds that query travel services for the user. The data feeds 139 may interface with the GDS to maintain real-time availability and price information for requested travel services even when the user is not actively connected to the travel management server 122. The data feeds 139 may include different, complex types that can be logically acted on at a group level, e.g. flights, or at an individual item level, e.g., a specific flight number. The travel workspace application 135 and workspace activities 133 are described in greater detail with reference to FIGS. 2 and 6.

The travel administrator 136 may be software that performs record-keeping services for the user. For example, the travel administrator 136 may create the expense report 138 for the itinerary 137. Further, the travel administrator 136 may determine whether incurred expenses are allowed by enterprise policies, and forward allowed expenses to the enterprise's billing or payment systems (not shown). The travel administrator 136 is described in greater detail with reference to FIGS. 3-5.

The storage 128 may include a travel card system 131, the itineraries 137, and the expense reports 138. The travel card system 131 may aggregate the travel cards 194 to enable the user to search for travel services in a flexible search format. The travel card system 131 is described in greater detail with reference to FIG. 1C.

FIG. 1C illustrates the travel card system 131 in accordance with implementations described herein. The travel card system 131 may include a crawler 161, an indexer 162, a query engine 163, a crawler database 164, and indices 165. The crawler 161 may search the network 160 for the travel cards 194, and aggregate the travel cards 194 in the crawler database 164.

The indexer 162 may create the indices 165 to enable the user to search for travel services described in the travel cards 194. The indices 165 may include standard search fields, such as hotel location and rating. However, the indexer 162 may also create other indices that are based on customizations of the travel cards 194 by the travel service providers. For example, a hotel may include in their travel cards 194 a description of nearby attractions. Accordingly, the indexer 162 may create an index for nearby attractions. The index for nearby attractions may enable the user to search not just for 4-star hotels in London, but hotels near Trafalgar Square as well.

The query engine 164 may be software that receives the user's search query, and returns a list of the travel cards 194 that are relevant. In one implementation, the query engine 164 may receive the search query from the data feeds 139.

FIG. 2A illustrates a screen shot of a travel workspace client 200 in accordance with implementations of various technologies described herein. The travel workspace client 200 may be a web client implementation of the user interface 114. Further, the travel workspace client 200 may maintain state information about the workspace activities 133 such that the user may logoff and logon to the travel workspace client 200 without losing any information maintained on the travel workspace client 200.

The travel workspace client 200 may include a query window 202, a search results window 204, one or more workspace activity windows 206, and a travel binder link 210. The query window 202 may be configured to enable the user to enter search terms. In one implementation, the results of the search may be displayed within the search results window 204. The workspace activity window 206 may be opened in response to the user clicking on one of the search results within the search results window 204.

In this example, the user enters the term, “FLIGHTS TO LONDON” in the query window 202. Two results may be returned in the search results window 204, “ENGLAND AIRLINES”, and “UNITED KINGDOM SKIES.”

In response to the user clicking on “ENGLAND AIRLINES,” the travel workspace client 200 may open the workspace activity window 206A. In this example, the workspace activity window 206 lists two flights to London and the fares for the flights. In one implementation, the workspace activity window 206 may be configured such that by clicking on one of the listed flights, the user may book a seat on the flight.

In another implementation, the search results may be returned as one of the data feeds 139. In the scenario described above, the data feed 139 may be a flight search query that is rendered in the search results window 204 by an applet that is specifically designed to search for flights.

While some interactions for travel services, such as booking, may be standard in the travel workspace client 200, the activity window interactions and content may be defined by the travel service provider. The workspace activity windows 206 may host applets that present a rich, multimedia presentation in association with the travel service. In one implementation, the travel workspace client 200 may be configured to support Microsoft® Silverlight applications for presenting interactive content within the workspace activity windows 206. In one implementation, these applets may be launched off the result set of one of the data feeds 139.

It should be noted that a search for flights is merely one example of workspace activities 133 in the travel workspace client 200. The travel workspace client 200 may be configured to search and interact with any form of travel activities and is merely limited to the content that the user wishes to review. For example, the travel workspace client 200 also includes workspace activity windows 206B and 206C for “LONDON HOTELS” and “TRAFALGAR SQUARE.”

Additionally, the travel workspace client 200 may maintain a persistent state, such that the user may logoff and later return to see the travel workspace client 200 in the same state that the user left it in. The content and state of each workspace activity window 206 may be maintained as one of the workspace activities 133 on the travel management server 122. Further, the user may subscribe to the data feeds 139 such that the data in the workspace activity windows 206 is kept current even when the user is logged off. In the example shown, the user may subscribe to the data feed 139 for the flights to London. In such a scenario, the user may logoff, then upon re-connecting to the travel workspace client 200, the user may view updated fares in the search results window 204. Although flights are used in this example, the data kept current by the data feeds 139 could include any manner of information from local events, to weather, or any other travel service information presented in the travel workspace client 200.

In addition to trip planning activities, the travel workspace client 200 may include workspace activity windows 206 for historical and active trips. Workspace activity windows 206 for active trips may be used to manage trip details, both in retrieving and updating relevant information. The user could actively update their own location in order to keep fellow travelers updated. The user could use the travel workspace client 200 to receive notifications about travel disruptions, use interactive maps to get directions, track expenses, and other activities to manage active trips.

The travel workspace client 200 may also include links to travel binders that organize information in active or historical itineraries. The travel binder link 210 may be configured to display a travel binder 220 for one of the itineraries 137. In the example shown, the travel binder 220 may aggregate the travel cards 194 associated with the travel binder link 210 is associated with a “MIAMI TRIP” itinerary. The travel binder 220 is described in greater detail with reference to FIGS. 2B and 2C.

Additionally, the travel workspace client 200 may enable the user to access the virtual travel agent 134 to ask questions using instant messaging. Further, the virtual travel agent 134 may occasionally provide notifications to the user via the travel workspace client 200.

Additionally, the user may dock the workspace activity windows 206 within the travel workspace client 200. The travel workspace client may have zero, one, or many docks, each of which can be logically attached to a part of the workspace, a part of the screen, or free floating.

FIG. 2B illustrates the travel binder 220, in accordance with implementations of various technologies described herein. The travel binder 220 may be an interface that organizes information about the user's itinerary 137. The travel binder 220 may include a tab bar 230, and travel card links 240. The tab bar 230 may include tabs that categorize information about the itinerary. For example, the “MIAMI TRIP” tab may include general information about the itinerary, such as travel dates, or meetings associated with the itinerary. The “EXPENSES” tab may include information about expenses for the itinerary. In one implementation, by clicking on the “EXPENSES” tab, the user may enter expense information in the travel binder 20.

The tab bar 230 may also include categories of travel services, such as “FLIGHTS” and “HOTELS.” By clicking on the “HOTELS” tab, the user may view specific room reservation information for the itinerary. In one implementation, the travel binder 220 may include travel card links 240. By clicking on the travel card links 240, the user may view the travel card 194 for a specific travel service.

FIG. 2C illustrates a travel card interface 250, in accordance with implementations described herein. The travel card interface 250 may include a title 252, an image 254, thumbnails 256, a description 258, and an action button 259. The image 254 and thumbnails 256 are merely an example of content that the travel service provider may include in the travel cards 194, and are not intended to limit implementations described herein.

The description 258 may include any information provided by the travel service provider in the travel card 194. “STAR RATING,” “NIGHTLY RATE,” and “NEARBY ATTRACTIONS” are merely examples of possible descriptions and are not intended to limit implementations described herein.

In one implementation, the travel card interface 250 may include the action button 259 to launch the presentation application 196 associated with the travel card 194. In this example, the user may take a virtual tour of the hotel by clicking on the action button 259. The action button 259 is merely one example of how the presentation application 196 may be launched and is not intended to limit implementations described herein.

FIG. 3 illustrates a flow chart of a method 300 for creating the itinerary 137, according to implementations of various technologies described herein. In one implementation, the method 300 may be performed by the virtual travel agent 134.

At step 310, the virtual travel agent 134 may receive a travel request from the user. The travel request may include an identifier for user, and the departure and destination cities.

At step 320, the virtual travel agent 134 may determine the enterprise data 156 for creating the itinerary 137. The enterprise information 156 may specify policies for selecting and/or booking travel services.

In one implementation, the travel request may be associated with a meeting scheduled on the user's calendar. In such an implementation, the virtual travel agent 134 may determine all the attendees of the meeting, and treat the travel request as a travel request for each attendee of the meeting. Additionally, the virtual travel agent 134 may determine travel dates based on each of the travelers' calendars.

The virtual travel agent 134 may also use historical information in the itineraries 137 to select travel services for the current travel request. For example, on trips to the same locale, other employees of the corporation may have all stayed at a particular hotel. The virtual travel agent 134 may select the same hotel for the current request.

At step 330, the virtual travel agent 134 may determine traveler information. The traveler information may include user-level information stored in the user profiles 158. The traveler information may be used to determine departure dates and times if the user profile 158 includes a preference for lead time to arrive before a meeting. Further, the user profile 158 may include a preference for departures/arrivals at a certain time of day.

At step 340, the virtual travel agent 134 may determine travel elements to fulfill the trip request. For example, on a trip from Seattle to London, the virtual travel agent 134 may determine that travel elements for the trip includes a taxi to the Seattle airport, a flight from Seattle to London, a rental car for local transport, and a hotel room for the duration of the stay in London.

At step 350, the virtual travel agent 134 may generate the itinerary 137 by selecting the travel elements. In one implementation, the virtual travel agent 134 may communicate with the GDS to select available transport and accommodations for the itinerary 137. The selection of particular travel elements may be further based on the enterprise data 156 and the user profile 158. In another implementation, the virtual travel agent 134 may generate multiple itineraries 137 for the user to choose from. In such a case, different combinations of travel elements may be selected for each of the itineraries 137.

At step 360, the virtual travel agent 134 may determine whether the itinerary is approved. In one implementation, the approval may be automated. For example, the approval may be determined based on the enterprise data 156. For example, the itinerary 137 may be approved if the cost falls beneath a certain value. In another implementation, the user may specify that a manual approval is required. Alternately, the travel request may include parameters within which the itinerary 137 may be approved.

If the itinerary 137 is approved, at step 370, the virtual travel agent 134 may book the travel elements in the itinerary 137. Alternately, an approved itinerary may merely authorize the virtual travel agent 134 to reserve or place a hold on the selected travel elements.

In another implementation, the virtual travel agent 134 may be a pro-active software application that responds to travel disruptions. In such an implementation, the virtual travel agent 134 may treat a travel disruption of an active itinerary as a travel request. For example, a connecting flight for the user may be canceled while the user is unavailable. The user may be onboard another flight, or the user's phone may be out of network. In response to the cancellation, the virtual travel agent 134 may book the user on another flight, as described in steps 320-370. It should be noted that a flight cancellation is merely used as an example of a travel disruption, and is not intended to limit implementations described herein. Other disruptions that impact booked itineraries may also be treated as travel request, such as re-scheduling a meeting for which travel is booked.

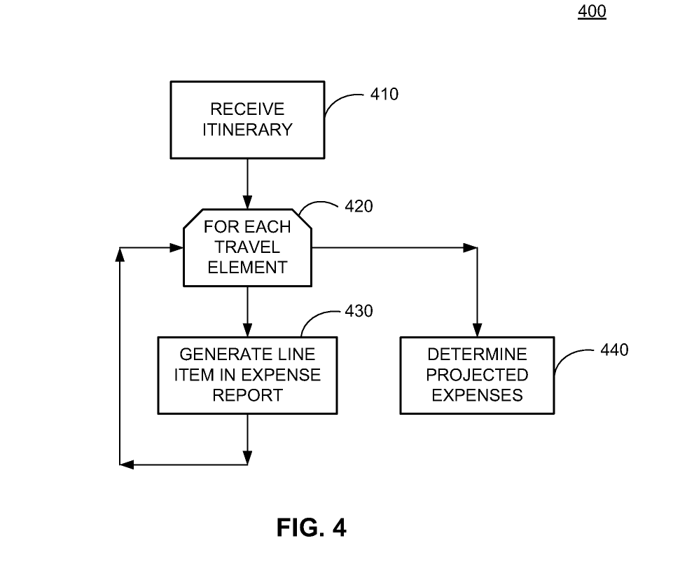

FIG. 4 illustrates a flow chart of a method 400 for generating expense reports 138, in accordance with implementations described herein. In one implementation, the travel administrator 136 performs the method 400.

At step 410, the travel administrator 136 may receive an itinerary 137 from the virtual travel agent 134. In one implementation, the virtual travel agent 134 may forward the itinerary to the travel administrator 136 after the travel elements of the itinerary 137 are booked.

Steps 420-430 may be repeated for each travel element in the itinerary 137. At step 430, the travel administrator 136 may generate a line item for the expense report 138. The line item may include a description of the travel element, e.g., airfare from Seattle to London, and a cost of the travel element.

At step 440, the travel administrator 136 may determine projected expenses for the itinerary 137. The projected expenses may be based on historical data in the itineraries 137 for previous trips to the same destination. Additionally, the projected expenses may be based on historical data in the itineraries for previous trips by the same travelers. The projected expenses may be included in the expense report 138 with a line item for each projected expense. In one implementation, the approval for the itinerary 137 (as described in FIG. 3) may be based on the projected expenses in the expense report 138.

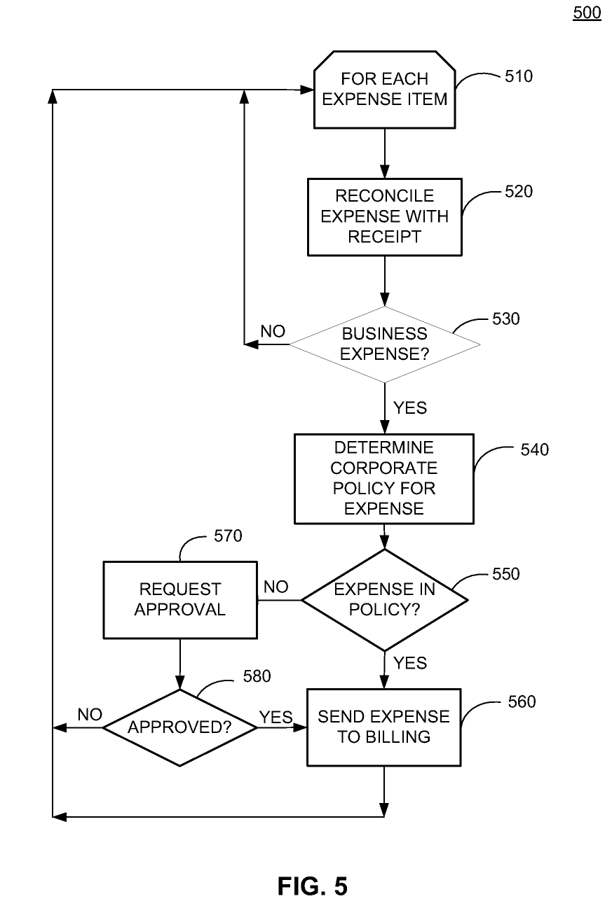

FIG. 5 illustrates a flow chart of a method 500 for validating travel expenses, according to implementations of various technologies described herein. In one implementation, the travel administrator 136 may perform the method 500. Travel expenses may include out of pocket expenses for the user, or expenses charged to a corporate credit card. In one implementation, the user may submit out of pocket expenses to the travel administrator 136 via the user interface 114. Alternately, expenses charged to a corporate credit card may be submitted to the travel administrator via a credit card feed from a bank.

Steps 510-560 may be repeated for each expense item that is incurred during a trip. At step 520, the travel administrator 136 may reconcile the out-of-pocket expense item with a receipt. For example, the expense item may be reconciled with a receipt that is submitted electronically, e.g., via the user interface 114 with an image capture. In one implementation, the travel administrator 136 may use optical character recognition (OCR) to determine the content of an image of the receipt, and reconcile the receipt with the expense item.

At step 530, the travel administrator 136 may determine whether the expense item is a business expense. In one implementation, the user may tag each expense item as personal or business. If the expense item is a personal expense, the method 500 may return to step 510. If the expense item is a business expense, at step 540, the travel administrator 136 may determine corporate policy for the expense item. The corporate policy may be included in the enterprise data 156.

At step 550, if the expense item is within corporate policy, the expense may be allowed. As such, at step 560, the expense item may be sent to a billing system (for reimbursement in the case of out-of-pocket expenses, or for payment in the case of charges to a corporate credit card).

If the expense item is not within corporate policy, at step 570, the travel administrator 136 may request approval for the expense. If the approval is obtained, at step 560, the expense item may be sent to the billing system. If the approval is not obtained, the method 500 may return to step 510.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating an expense report, comprising:
receiving an itinerary for travel;
generating a description and a cost for one or more travel elements of the itinerary; and
generating projected expenses that are expected to be incurred based on historical data associated with the itinerary.

2. The method of claim 1, wherein the historical data are based on a previous travel to a destination inside the itinerary.

3. The method of claim 1, wherein the historical data are based on one or more previous travels of one or more travelers to a destination inside the itinerary.

4. The method of claim 1, further comprising approving the itinerary for purchase based on the projected expenses.

5. A method for validating an expense item in an expense report, comprising:
receiving an expense item;
reconciling the expense item with a receipt for the expense item;
determining a corporate policy for the expense item; and
determining whether the expense item is valid based on the corporate policy.

6. The method of claim 5, further comprising sending the expense item to a billing system.

7. The method of claim 5, further comprising:
determining that the expense item is not valid; and
requesting an approval for an expense corresponding to the expense item.

8. The method of claim 7, further comprising:
receiving the approval; and
sending the expense to a billing system.

9. The method of claim 5, wherein the expense item is an out of pocket expense.

10. The method of claim 5, wherein the expense item is a charge to a corporate credit card.

11. The method of claim 5, wherein reconciling the receipt is obtained through a credit card feed from a bank.

12. The method of claim 5, wherein reconciling the receipt is obtained through an image capture technology or an optical character recognition.

13. A computer-readable medium comprising computer instructions which, when executed by a processor, cause the computer to:
receive an expense item;
reconcile the expense item with a receipt for the expense item;
determine a corporate policy for the expense item;
determine whether the expense item is valid based on the corporate policy; and
if the expense item is not valid, request an approval for an expense corresponding to the expense item.

14. The computer-readable medium of claim 13, further comprising computer-executable instructions which, when executed by the processor, cause the computer to:
receive the approval; and
send the expense to a billing system.

15. The computer-readable medium of claim 13, further comprising computer-executable instructions which, when executed by the processor, cause the computer to determine that the expense item is valid.

16. The computer-readable medium of claim 17, further comprising computer-executable instructions which, when executed by the processor, cause the computer to send the expense item to a billing system in response to determining that the expense item is valid.

17. The computer-readable medium of claim 13, wherein the expense item is an out of pocket expense.

18. The computer-readable medium of claim 13, wherein the expense item is a charge to a corporate credit card.

19. The computer-readable medium of claim 13, wherein the expense item is reconciled with the receipt through a credit card feed from a bank.

20. The computer-readable medium of claim 13, wherein the expense item is reconciled with the receipt through an image capture technology or an optical character recognition.
